(19) United States
(12) Patent Application Publication
(10) Pub. No.: US 2026/0031855 A1
(43) Pub. Date: Jan. 29, 2026

(54) SEMICONDUCTOR DEVICE FOR REDUCING CROSSTALK NOISE

(71) Applicants: SK Hynix Inc., Icheon-si (KR); Seoul National University R&DB Foundation, Seoul (KR)

(72) Inventors: Sangouk JEON, Seoul (KR); Seoyoon Jang, Seoul (KR); Dongsuk Jeon, Seoul (KR); Hankyu Chi, Icheon-si (KR); Wookjin Shin, Icheon-si (KR); Changhyun Pyo, Icheon-si (KR)

(21) Appl. No.: 18/933,003

(22) Filed: Oct. 31, 2024

(30) Foreign Application Priority Data
Jul. 25, 2024 (KR) 10-2024-0098853

(51) Int. Cl. H04B 3/32

(52) U.S. Cl. CPC H04B 3/32

(57) ABSTRACT

A semiconductor device includes a first encoding circuit configured to encode data to generate encoding data including a plurality of symbols; and a second encoding circuit configured to generate transmission data by performing an operation on previous transmission data and the encoding data. A plurality of data lines of the semiconductor device are arranged in a grid pattern, and each of the plurality of symbols corresponds to a column of the data lines in the grid pattern. The first encoding circuit encodes the data to prevent a signal on each of one or more of aggressor lines from transitioning when a signal on a victim line transitions. The victim line is a data line included in an inner row of the data lines and each of the aggressor lines is a data line located adjacent to the victim line.

### CROSS-REFERENCE TO RELATED APPLICATION

The present application claims priority under 35 U.S.C. § 119(a) to Korean Patent Application No. 10-2024-0098853, filed on Jul. 25, 2024, which is incorporated herein by reference in its entirety.

### BACKGROUND

### 1. Technical Field

Embodiments of the present disclosure each generally relate to a semiconductor device that reduces crosstalk noise.

### 2. Related Art

The parallel interface of a high bandwidth memory (HBM) device includes a relatively large number of data lines, and it is desirable to minimize crosstalk noise thereof.

Although inter-symbol interference (ISI) noise can be removed using an equalizer, it may be difficult to fundamentally remove crosstalk noise even with the equalizer.

Accordingly, a technology has been proposed to provide crosstalk noise by coding data transmitted through a relatively large number of data lines.

For example, a Crosstalk Avoidance Codes (CAC) technique based on the Fibonacci sequence has been proposed.

These eliminate the factor that has the greatest effect on crosstalk noise by preventing three consecutive bits from transitioning.

However, these conventional coding techniques have a relatively large overhead due to the addition of bits, making it difficult to apply them to devices with large bandwidths such as a HBM device.

In addition, the existing coding techniques is optimized for a specific interface structure, so they are not desirable for removing crosstalk noise when they are applied to HBM as is.

Moreover, the existing coding techniques assume that only one factor, either capacitive coupling or inductive coupling, is significant in affecting crosstalk noise, without accounting for both effects simultaneously. This limitation undermines the general applicability of the approach.

### SUMMARY

In accordance with an embodiment of the present disclosure, a semiconductor device may include a first encoding circuit configured to encode data to generate encoding data including a plurality of symbols; and a second encoding circuit configured to generate transmission data by performing an operation on previous transmission data and the encoding data, wherein a plurality of data lines of the semiconductor device are arranged in a grid pattern, and each of the plurality of symbols corresponds to a column of the data lines in the grid pattern, wherein the first encoding circuit encodes the data to prevent a signal on each of one or more of aggressor lines from transitioning when a signal on a victim line transitions, and wherein the victim line is a data line included in an inner row of the data lines and each of the aggressor lines is a data line located adjacent to the victim line.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a semiconductor device according to an embodiment of the present disclosure.

FIG. 2 illustrates an encoding circuit according to an embodiment of the present disclosure.

FIG. 3 illustrates an arrangement of data lines and an operation of an encoding circuit according to an embodiment of the present disclosure.

FIG. 4 illustrates a first encoding circuit according to an embodiment of the present disclosure.

FIG. 5 illustrates a lookup table included in a bit encoding circuit and an operation thereof according to an embodiment of the present disclosure.

FIGS. 6, 7, 8, 9, 10 and 11 illustrate an operation of an encoding circuit according to an embodiment of the present disclosure.

### DETAILED DESCRIPTION

The following detailed description references the accompanying figures in describing illustrative embodiments consistent with this disclosure. These embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of various embodiments of the present disclosure is defined in accordance with claims and equivalents thereof. Also, throughout the specification, reference to “an embodiment” or the like is not necessarily to only one embodiment, and different references to any such phrase are not necessarily to the same embodiment(s).

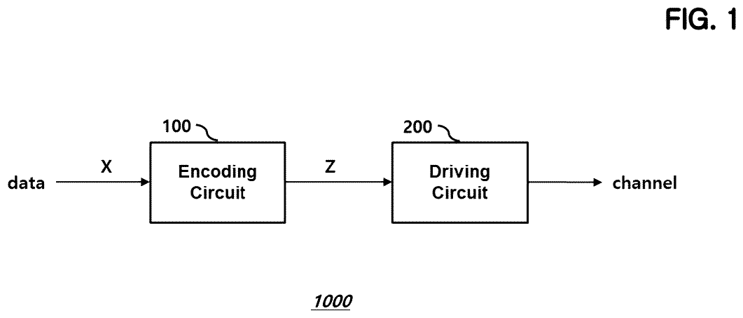

FIG. 1 is a block diagram showing a semiconductor device 1000 according to one embodiment of the present disclosure.

The semiconductor device 1000 includes an encoding circuit 100 that receives data X and generates transmission data Z and a driving circuit 200 that drives a channel to transmit the transmission data Z.

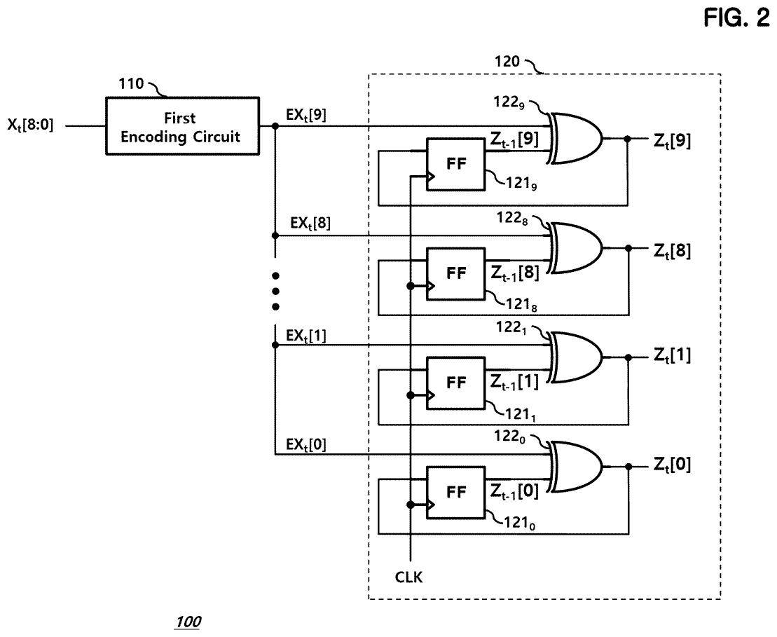

FIG. 2 is a block diagram showing the encoding circuit 100 according to an embodiment of the present disclosure.

The encoding circuit 100 includes a first encoding circuit 110 and a second encoding circuit 120.

The first encoding circuit 110 receives data Xₜ and generates encoding data EXₜ.

The subscript t in the symbol indicates a current time.

The second encoding circuit 120 generates current transmission data Zₜ using the encoding data EXₜ and previous transmission data Zₜ₋₁ transmitted at a previous time. For example, the previous time t−1 may be a time immediately preceding the current time t by a predetermined time interval.

In the following disclosure, it is assumed that data includes 9 bits, and both encoding data and transmission data include 10 bits, but the number of bits thereof may vary according to embodiments.

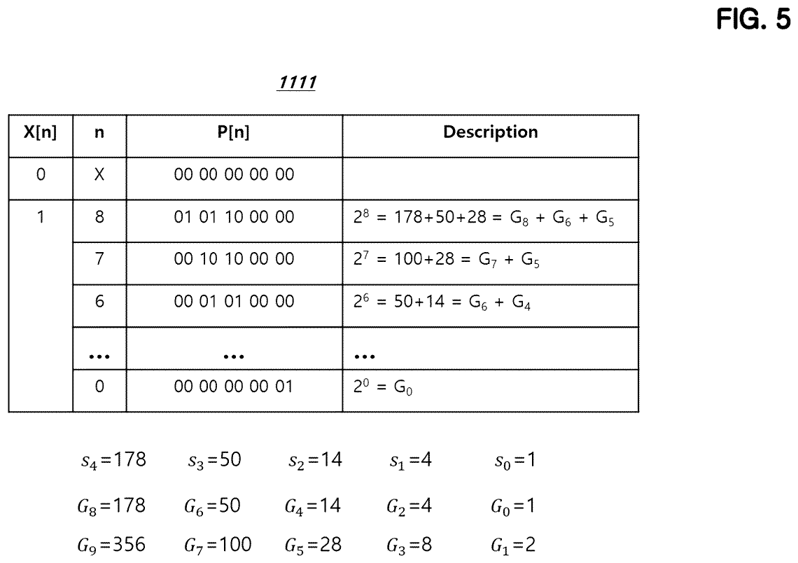

A specific configuration and operation of the first encoding circuit 110 will be described below in more detail with reference to FIG. 5.

The second encoding circuit 120 includes one or more of flip-flops 121 and one or more of logical operation circuits (e.g., a plurality of XOR operation circuits) 122.

A subscript in each of the reference numbers referring to the flip-flops 121 and the XOR operation circuits 122 represents a corresponding bit number.

The plurality of flip-flops 121 provide the previous transmission data Zₜ₋₁ from the transmission data Zₜ. Specifically, each of the plurality of flip-flops 121 provides a corresponding bit of the previous transmission data Zₜ₋₁ to a corresponding one of the XOR operation circuits 122 in response to a clock signal CLK.

The XOR operation circuit 122 performs an XOR operation on the encoding data EXₜ and the previous transmission data Zₜ₋₁ to generate the current transmission data Zₜ. Specifically, each of the XOR operation circuits 122 performs an XOR operation on a corresponding bit of the encoding data EXₜ and a corresponding bit of the previous transmission data Zₜ₋₁ to generate a corresponding bit of the current transmission data Zₜ.

For example, the XOR operation circuit 1229 corresponding to the 9th bit generates the 9th bit Zₜ[9] of the current transmission data Zₜ by performing an XOR operation on the 9th bit EXₜ[9] of the encoded data and the 9th bit Zₜ₋₁[9] of the previous transmission data Zₜ₋₁.

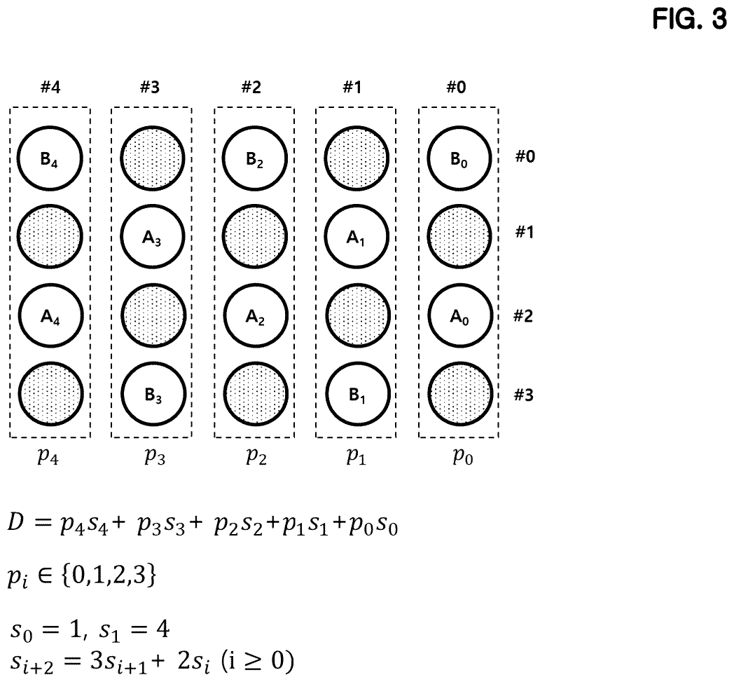

FIG. 3 illustrates the arrangement of data lines and the operation of the encoding circuit 100 according to an embodiment of the present disclosure.

FIG. 3 illustrates data lines used in a high bandwidth memory (HBM) device, where a data line indicated in white represents a data line through which data is transmitted, and a data line indicated in a dot pattern represents a ground line. For example, the data lines may be used to transmit the transmission data Z therethrough in the HBM device.

In the embodiment of FIG. 3, a plurality of data lines are arranged in a grid pattern including four rows and five columns. However, embodiments of the present disclosure are not limited thereto, and the numbers of rows and columns of a grid pattern may vary according to embodiments.

Hereinafter, row numbers are indicated as #0, #1, #2, and #3 from top to bottom, and column numbers are indicated as #0, #1, #2, #3, and #4 from right to left.

Among the data lines indicated in FIG. 3, inner rows are more affected by crosstalk noise than outer rows. That is, rows #1 and #2 are more affected by crosstalk noise than rows #0 and #3. For example, the outer rows may be defined as a pair of outermost rows (e.g., rows #0 and #3 in FIG. 3) in the grid pattern, and the inner rows may be defined as the remaining rows (e.g., rows #1 and #2) disposed within the outermost rows in the grid pattern. However, embodiments of the present disclosure are not limited thereto, and the number of inner rows and the number of outer rows may vary according to embodiments.

In this embodiment, the first encoding circuit 110 encodes data X so that inner rows are less affected by crosstalk noise.

In this embodiment, encoding data EX is divided by 2-bit units to set multiple symbols, and each symbol is assigned to a corresponding column.

At this time, the upper bit of one symbol corresponds to an inner row, and the lower bit corresponds to an outer row. With this rule, 10-bit encoding data EX can be assigned from column #0 to column #4.

That is, bit #0 of encoding data EX is assigned to data line B₀ corresponding to column #0 and row #0, and bit #1 is assigned to data line A₀ corresponding to column #0 and row #2. Similarly, bit #8 of data X is assigned to data line B₄ corresponding to column #4 and row #0, and bit #9 is assigned to data line A₄ corresponding to column #4 and row #2.

If two bits corresponding to each column are represented as a single symbol p, each symbol has a value of 0, 1, 2, or 3. If a symbol corresponding to column #i is represented as pᵢ and a basis value corresponding to the symbol is represented as sᵢ, the value D of the data can be expressed as in Equation 1:

$$D = {p}_{4} {s}_{4} + {p}_{3} {s}_{3} + {p}_{2} {s}_{2} + {p}_{1} {s}_{1} + {p}_{0} {s}_{0} . \qquad [ Equation 1 ]$$

In this embodiment, the basis values corresponding to symbols have a relationship as shown in Equation 2:

$${s}_{0} = 1 , {s}_{1} = 4 , {s}_{i + 2} = 3 {s}_{i + 1} + 2 {s}_{i} ( i \geq 0 ) . \qquad [ Equation 2 ]$$

Hereinafter, a method for generating 10-bit encoding data EX from 9-bit data X will be specifically described in more detail.

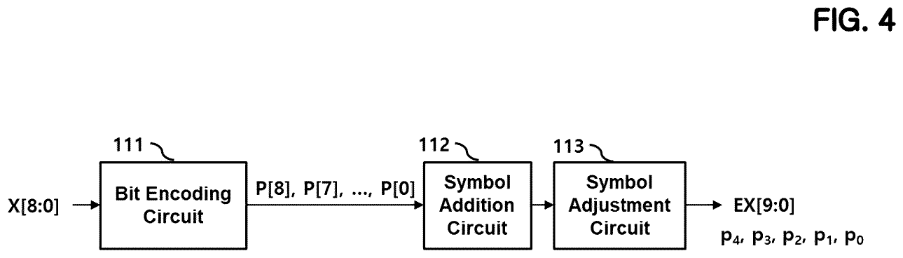

FIG. 4 is a block diagram showing the first encoding circuit 110 according to an embodiment of the present disclosure.

The first encoding circuit 110 includes a bit encoding circuit 111 and a symbol addition circuit 112, and may further include a symbol adjustment circuit 113.

The bit encoding circuit 111 generates a plurality of encoding vectors P[n] each corresponding to each bit of data X, where n is a bit number from 0 to 8. At this time, each encoding vector P[n] includes 10 bits.

The bit encoding circuit 111 can include a lookup table 1111 to look up an encoding vector corresponding to each bit of data X. For example, the lookup table 1111 stores a precalculated plurality of encoding vectors each corresponding to a value (e.g., 0 or 1) and a bit number n (e.g., 0 to 8) of a corresponding one of a plurality of bits included in the data X.

FIG. 5 shows the structure of the lookup table 1111 and method for generating the lookup table 1111.

In FIG. 5, the description shows a method of generating an encoding vector corresponding to each bit of data.

In Equation 2, sᵢ represents a basis value corresponding to the i-th symbol.

In this embodiment, each symbol includes 2 bits, and if the basis value corresponding to each bit is represented as G, the basis value G₂ᵢ, where i=0, 1, 2, 3, 4, corresponding to the lower bit in each symbol is equal to the basis value sᵢ of the corresponding symbol, and the basis value G₂ᵢ₊₁ corresponding to the upper bit in each symbol is equal to twice the basis value sᵢ of the corresponding symbol.

When X[n]=0, the encoding vector P[n] is “00 00 00 00 00” regardless of n.

When X[8]=1, since X[8]=256=G₈+G₆+G₅, the encoding vector P[8] is “01 01 10 00 00.” In this way, encoding vectors respectively corresponding to bit values and bit numbers can be determined in advance and stored in the lookup table 1111.

The symbol addition circuit 112 adds multiple encoding vectors symbol by symbol.

For example, the symbol addition circuit 112 adds 0th symbols of multiple encoding vectors to output 0th symbol, and adds 1st symbols to output 1st symbol.

In this embodiment, each symbol must have one of the values 0, 1, 2, and 3, but the symbol output as a result of addition using multiple encoding vectors can have a value greater than 3.

The symbol adjustment circuit 113 adjusts the value output from the symbol addition circuit 112 to ensure that each symbol's value is in a given range (e.g., an allowed range). For example, when a symbol includes two bits, the allowed range may be from 0 to 3.

At this time, the symbol adjustment circuit 113 adjusts the symbol value by referring to the relationship in Equation 2.

For example, an operation to adjust symbol number #4 p₄ will be described below.

[Condition 1] If p₃ is greater than or equal to 3 and p₂ is greater than or equal to 2, then according to the relationship s₄=3s₃+2s₂, the value of p₄ should be increased by 1, the value of p₃ should be decreased by 3, and the value of p₂ should be decreased by 2.

[Condition 2] If condition 1 is not satisfied and the value of p₃ is greater than or equal to 4 (i.e., if p₃ is greater than or equal to 4 and p₂ is less than 2), then according to the relationship s₄=3s₃+2s₂, s₃=3s₂+2s₁, the value of p₄ should be increased by 1, the value of p₃ should be decreased by 4, the value of p₂ should be increased by 1, and the value of pᵢ should be increased by 2.

The adjustment operation is repeated until both conditions 1 and 2 above are not satisfied, and the adjustment for symbol #4 p₄ is completed.

Once the adjustment for symbol #4 p₄ is completed, adjustments are performed sequentially for lower symbols in a similar manner. By performing this operation, the symbol adjustment circuit 113 outputs 10-bit encoding data EX. As a result, the encoding data EX includes the symbols p₀ to p₄ each having a value in a predetermined range (e.g., 0 to 3).

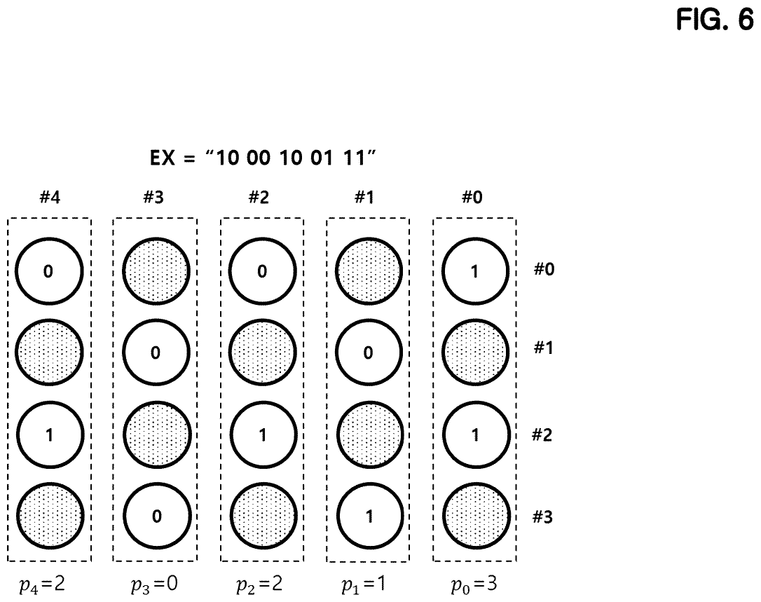

FIG. 6 illustrates an example in which the encoding data EX is “10 00 10 01 11” and is allocated to multiple data lines.

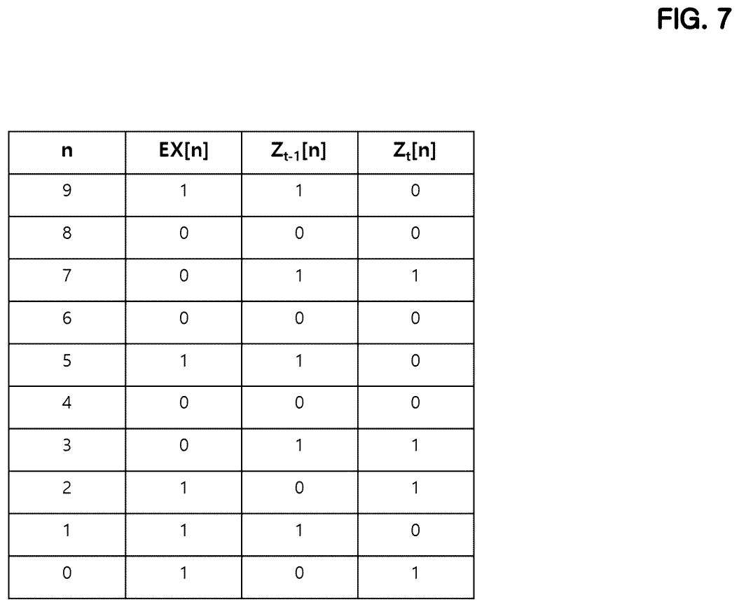

FIG. 7 is a diagram illustrating an operation of the second encoding circuit 120.

In FIG. 7, the previous transmission data Zₜ₋₁ is assumed to be “10 10 10 10 10.”

Since the transmission data Zₜ corresponds to the result of the XOR operation on the previous transmission data Zₜ₋₁ and the encoding data EX, the transmission data Zₜ is “00 10 00 11 01.”

The driving circuit 200 drives multiple data lines included in the channel using the transmission data Zₜ determined in this manner.

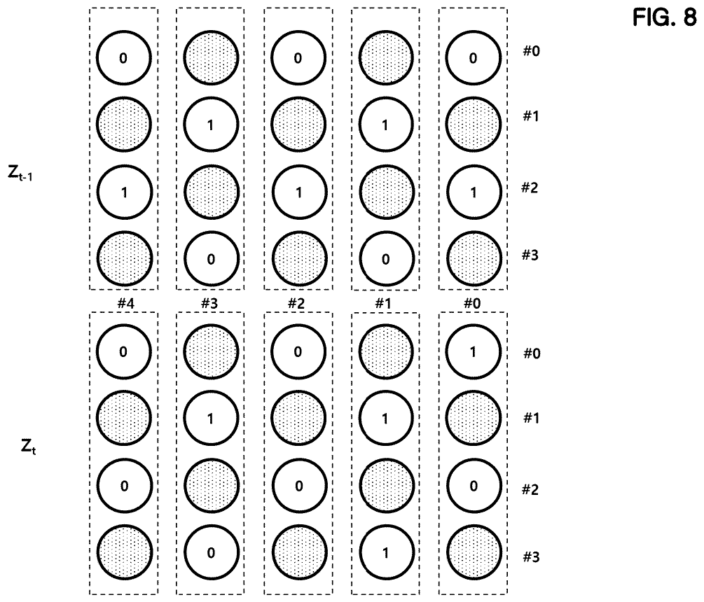

FIG. 8 shows the previous transmission data Zₜ₋₁ and the current transmission data Zₜ of FIG. 7 together.

This embodiment aims at reducing crosstalk noise in the inner data lines.

Hereinafter, a data line affected by noise is referred to as a victim line, and a data line generating crosstalk noise is referred to as an aggressor line. Crosstalk noise is at its worst when the victim line transitions and all the aggressor lines also transition. In other words, when a signal on a victim line and a signal in each of one or more aggressor lines transition simultaneously, the victim line is severely impacted by crosstalk noise.

If any one of the data lines located in the column #3 of the row #1 in FIG. 8 is designated as a victim line, four data lines, i.e., aggressor lines, are located around the victim line. Specifically, the aggressor lines (e.g., at row #0 & column #4, row #2 & column #4, row #0 & column #2, and row #2 & column #2) are located adjacent to the victim line (e.g., at row #1 & column #3).

This embodiment aims at reducing crosstalk noise at the victim line by reducing the number of aggressor lines that transition together with the victim line.

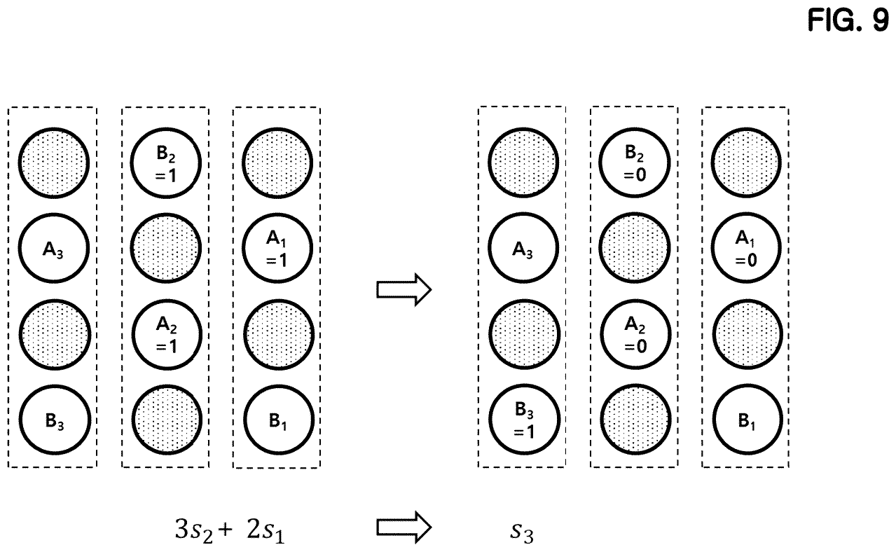

If encoding is performed while satisfying the Equation 2, there is no case where (Aᵢ₊₁, Bᵢ₊₁, Aᵢ) corresponds to (1, 1, 1) in the encoded data EX because the case (Aᵢ₊₁, Bᵢ₊₁, Aᵢ)=(1, 1, 1) is replaced by Bᵢ₊₂=1 and (Aᵢ₊₁, Bᵢ₊₁, Aᵢ)=(0, 0, 0) by the Equation 2. FIG. 9 illustrates the case where i=1.

The current transmission data Zₜ corresponds to the result of the XOR operation on the previous transmission data Zₜ₋₁ and the encoded data EX.

That is, in order for all the values of the data lines corresponding to the positions (Aᵢ₊₁, Bᵢ₊₁, Aᵢ) to transition between the previous transmission data Zₜ₋₁ and the current transmission data Zₜ, the values of the encoded data EX corresponding to the positions (Aᵢ₊₁, Bᵢ₊₁, Aᵢ) must be (1, 1, 1).

However, as mentioned above, since there is no case in which (Aᵢ₊₁, Bᵢ₊₁, Aᵢ) corresponds to (1, 1, 1) in the encoding data EX. Therefore, there is no case in which all the values of the transmission data Z corresponding to the positions (Aᵢ₊₁, Bᵢ₊₁, Aᵢ) transition at the same time. As a result, crosstalk noise at a victim line (e.g., Aᵢ) by adjacent aggressor lines (e.g., Aᵢ₊₁ and Bᵢ₊₁) may be significantly reduced compared to when a signal on the victim line and a signal on each of the adjacent aggressor lines transition simultaneously. In an embodiment, the first encoding circuit 110 may encode data X to prevent a signal on each of the aggressor lines from transitioning when a signal on the victim line transitions. For example, the first encoding circuit 110 may perform an encoding operation based on a relationship between a plurality of base values of a plurality of symbols, where the relationship is set to prevent one or more of a value corresponding to a victim line and values of at least two aggressor lines from having a logic high value (e.g., “1”). As used herein, including in the claims, “and” as used in a list of items (e.g., a list of items prefaced by a phrase such as “one or more of” or “one or both of”) indicates an inclusive list such that, for example, a list of one or more of A, B, and C indicates A or B or C or AB or AC or BC or ABC (i.e., A and B and C).

In FIG. 9, if Aᵢ is a victim line, A₂, B₂, A₀, and B₀ correspond to aggressor lines.

However, since there is no case in which (A₂, B₂, A₁) is (1, 1, 1), (A₂, B₂) cannot be 1 when the victim line Aᵢ is 1.

Therefore, when encoding is performed as in the embodiment, the worst case in which all aggressor lines transition together when the victim line transitions can be avoided.

That is, embodiments of the present disclosure can prevent the worst case from occurring regardless of capacitive coupling and inductive coupling.

The above-described embodiments each correspond to a case in which the number of rows of data lines is even to make the number of data lines included in each column the same, and therefore, all symbols have the same number of bits.

However, if the number of rows of data lines is odd, the number of data lines included in each column is different. In this case, the number of bits included in a symbol may be different depending on corresponding columns.

For example, if the number of rows is 3, the number of data lines varies between 1 and 2 depending on columns, and accordingly, the number of bits included in the symbol also varies between 1 and 2.

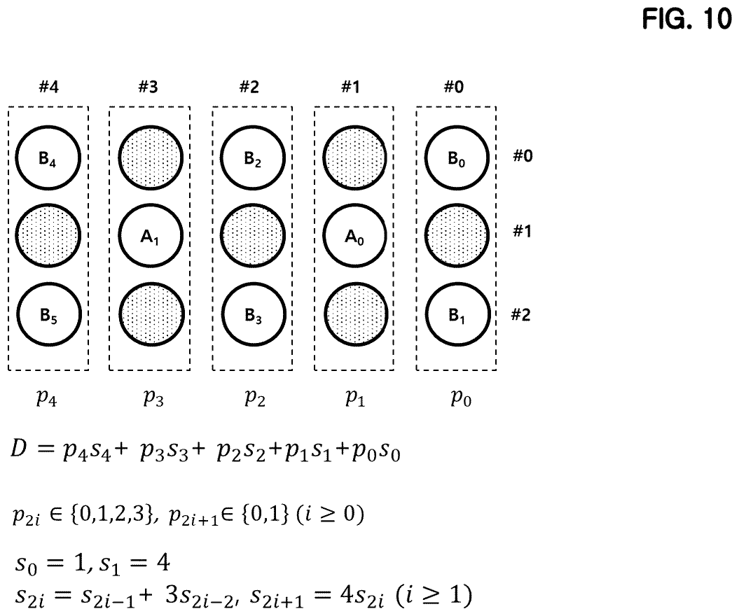

FIG. 10 shows an example in which data lines are arranged in 3 rows and 5 columns.

In this case, encoding operation is performed to prevent the worst case from occurring based on the victim line located in the inner row.

In FIG. 10, a symbol corresponding to columns #0, #2, or #4 includes 2 bits, and a symbol corresponding to columns #1 or #3 includes 1 bit.

Accordingly, a symbol corresponding to columns #0, #2, or #4 has one of the values 0, 1, 2, and 3, and a symbol corresponding to columns #1 or #3 has one of the values 0 and 1.

In the embodiment of FIG. 10, the basis values corresponding to the symbols have a relationship as Equation 3.

$${s}_{0} = 1 , {s}_{1} = 4 , {s}_{2 i} = {s}_{2 i - 1} + 3 {s}_{2 i - 2} , {s}_{2 i + 1} = 4 {s}_{2 i} ( i \geq 1 ) \qquad [ Equation 3 ]$$

When performing encoding according to the rule of Equation 3, there is no case in which (A₀, B₁, B₀) corresponds to (1, 1, 1) in the encoding data EX.

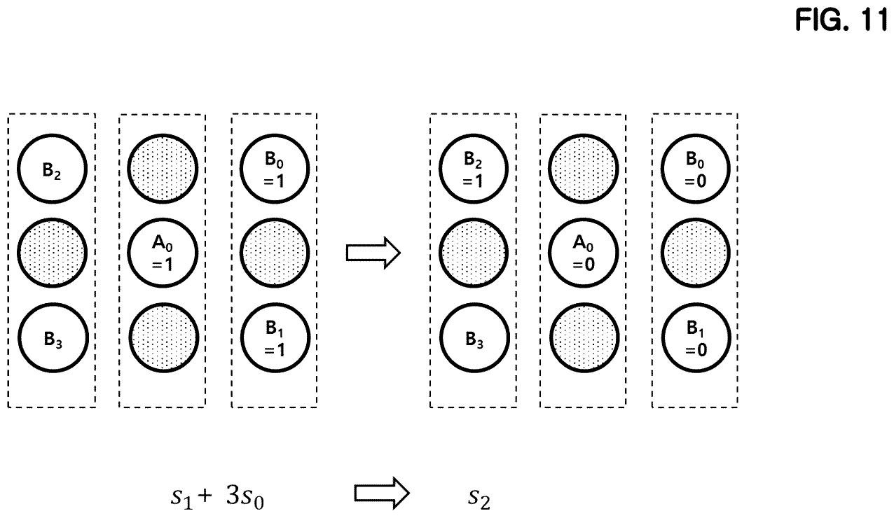

For example, referring to FIG. 11, a case where (A₀, B₁, B₀)=(1, 1, 1) is replaced with B₂₌₁ and (A₀, B₁, B₀)=(0, 0, 0) by the relationship of Equation 3.

This indicates that the worst case in which all aggressor lines corresponding to the victim line included in row #1 transition together does not occur according to the principle described above.

The first encoding circuit 110 disclosed with reference to FIG. 4 can also be applied to the encoding operation according to Equation 3.

Although the number of bits included in a symbol may differ depending on the position of the symbol, since a person of skilled in the art can implement the encoding operation according to Equation 3 in light of teachings from this disclosure, a repetitive explanation will be omitted for the interest of brevity.

In the above, embodiments in which a plurality of data lines included in a channel are arranged in three or four rows have been disclosed, but those skilled in the art can easily derive embodiments in which a greater number of rows are included by referring to the present disclosure.

In an embodiment, a method of operating a semiconductor device comprises: encoding data to generate encoding data including a plurality of symbols to prevent a signal on each of one or more of aggressor lines from transitioning when a signal on a victim line transitions; and generating transmission data by performing an operation on previous transmission data and the encoding data. A plurality of data lines of the semiconductor device are arranged in a grid pattern, and each of the plurality of symbols corresponds to a column of the data lines in the grid pattern. The victim line is a data line included in an inner row of the data lines and each of the aggressor lines is a data line located adjacent to the victim line.

In an embodiment, encoding the data comprises: generating a plurality of encoding vectors corresponding to a plurality of bits included in the data; and generating the encoding data by performing symbol-wise addition on the plurality of encoding vectors.

In an embodiment, the method further comprises storing a precalculated plurality of encoding vectors each corresponding to a value and a bit number of a corresponding one of the plurality of bits included in the data.

In an embodiment, the method further comprises generating the encoding data by adjusting a value of a symbol among a plurality of symbols that have been obtained from performing the symbol-wise addition on the plurality of encoding vectors, to ensure that the value of the symbol is in a given range.

In an embodiment, generating the transmission data comprises: generating the previous transmission data by latching the transmission data; and generating the transmission data by performing a bitwise logical operation on the previous transmission data and the encoding data.

In an embodiment, the logical operation is an XOR operation, encoding the data comprises performing an encoding operation based on a relationship between a plurality of base values of the plurality of symbols, and the relationship is set to prevent one or more of a value corresponding to the victim line and values of at least two of the aggressor lines from having a logic high value.

In an embodiment, the plurality of data lines include an even number of rows, each of the plurality of symbols includes 2 bits, and a plurality of base values sₖ corresponding to the plurality of symbols have the relationship as follows: s₀=1, s₁=4, sᵢ₊₂=3Sᵢ₊₁+2sᵢ (i≥0), where i is a symbol number and k is a column number.

In an embodiment, the plurality of data lines include an odd number of rows, each of the plurality of symbols corresponding to an even row includes 2 bits, each of the plurality of symbols corresponding to an odd row includes 1 bit, and a plurality of base values sₖ corresponding to the plurality of symbols have the relationship as follows: s₀=1, s₁=4, s₂ᵢ=s₂ᵢ₋₁+3s₂ᵢ₋₂, s₂ᵢ₊₁=4s₂ᵢ (i≥1), where i is a symbol number and k is a column number.

In an embodiment, generating the previous transmission data comprises providing a corresponding bit of the previous transmission data in response to a clock signal, and generating the transmission data comprises performing an XOR operation on the corresponding bit of the previous transmission data and a corresponding bit of the encoding data to generate a corresponding bit of the transmission data.

In an embodiment, the plurality of data lines transmit the transmission data in a high bandwidth memory (HBM) device.

Although various embodiments have been illustrated and described, various changes and modifications may be made to the described embodiments without departing from the spirit and scope of the invention as defined by the following claims.

What is claimed is:

1. A semiconductor device comprising:
a first encoding circuit configured to encode data to generate encoding data including a plurality of symbols; and
a second encoding circuit configured to generate transmission data by performing an operation on previous transmission data and the encoding data,
wherein a plurality of data lines of the semiconductor device are arranged in a grid pattern, and each of the plurality of symbols corresponds to a column of the data lines in the grid pattern,
wherein the first encoding circuit encodes the data to prevent a signal on each of one or more of aggressor lines from transitioning when a signal on a victim line transitions, and
wherein the victim line is a data line included in an inner row of the data lines and each of the aggressor lines is a data line located adjacent to the victim line.

2. The semiconductor device of claim 1, wherein the first encoding circuit includes:
a bit encoding circuit configured to generate a plurality of encoding vectors corresponding to a plurality of bits included in the data; and
a symbol addition circuit configured to generate the encoding data by performing symbol-wise addition on the plurality of encoding vectors.

3. The semiconductor device of claim 2, wherein the bit encoding circuit includes a lookup table storing a precalculated plurality of encoding vectors, each corresponding to a value and a bit number of a corresponding one of the plurality of bits included in the data.

4. The semiconductor device of claim 2, further comprising a symbol adjustment circuit configured to generate the encoding data by adjusting a value of a symbol among a plurality of symbols output from the symbol addition circuit to ensure that the value of the symbol is in a given range.

5. The semiconductor device of claim 1, wherein the second encoding circuit includes:
one or more flip-flops configured to generate the previous transmission data by latching the transmission data; and
one or more logical operation circuits configured to generate the transmission data by performing a bitwise logical operation on the previous transmission data and the encoding data.

6. The semiconductor device of claim 5, wherein the logical operation circuits of the second encoding circuit are XOR operation circuits,
wherein the first encoding circuit performs an encoding operation based on a relationship between a plurality of base values of the plurality of symbols, and
wherein the relationship is set to prevent one or more of a value corresponding to the victim line and values of at least two of the aggressor lines from having a logic high value.

7. The semiconductor device of claim 6, wherein the plurality of data lines include an even number of rows, each of the plurality of symbols includes 2 bits, and a plurality of base values sₖ corresponding to the plurality of symbols have the relationship as follows: s₀=1, s₁=4, sᵢ₊₂=3sᵢ₊₁+2sᵢ(i≥0), where i is a symbol number and k is a column number.

8. The semiconductor device of claim 6, wherein the plurality of data lines include an odd number of rows, each of the plurality of symbols corresponding to an even row includes 2 bits, each of the plurality of symbols corresponding to an odd row includes 1 bit, and a plurality of base values sₖ corresponding to the plurality of symbols have the relationship as follows: s₀=1, s₁=4, s₂ᵢ=s₂ᵢ₋₁+3s₂ᵢ₋₂, s₂ᵢ₊₁=4s₂ᵢ (i≥1), where i is a symbol number and k is a column number.

9. The semiconductor device of claim 5, wherein each of the flip-flops is configured to provide a corresponding bit of the previous transmission data in response to a clock signal; and
wherein each of the logical operation circuits configured to perform an XOR operation on the corresponding bit of the previous transmission data and a corresponding bit of the encoding data to generate a corresponding bit of the transmission data.

10. The semiconductor device of claim 1, wherein the plurality of data lines transmit the encoding data EX, or the transmission data, or both, in a high bandwidth memory (HBM) device.

11. A method of operating a semiconductor device, comprising:
encoding data to generate encoding data including a plurality of symbols to prevent a signal on each of one or more of aggressor lines from transitioning when a signal on a victim line transitions; and
generating transmission data by performing an operation on previous transmission data and the encoding data,
wherein a plurality of data lines of the semiconductor device are arranged in a grid pattern, and each of the plurality of symbols corresponds to a column of the data lines in the grid pattern, and
wherein the victim line is a data line included in an inner row of the data lines and each of the aggressor lines is a data line located adjacent to the victim line.

12. The method of claim 11, wherein encoding the data comprises:
generating a plurality of encoding vectors corresponding to a plurality of bits included in the data; and
generating the encoding data by performing symbol-wise addition on the plurality of encoding vectors.

13. The method of claim 12, further comprising storing a precalculated plurality of encoding vectors each corresponding to a value and a bit number of a corresponding one of the plurality of bits included in the data.

14. The method of claim 12, further comprising generating the encoding data by adjusting a value of a symbol among a plurality of symbols that have been obtained from performing the symbol-wise addition on the plurality of encoding vectors, to ensure that the value of the symbol is in a given range.

15. The method of claim 11, wherein generating the transmission data comprises:
generating the previous transmission data by latching the transmission data; and
generating the transmission data by performing a bitwise logical operation on the previous transmission data and the encoding data.

16. The method of claim 15, wherein the logical operation is an XOR operation,
wherein encoding the data comprises performing an encoding operation based on a relationship between a plurality of base values of the plurality of symbols, and
wherein the relationship is set to prevent one or more of a value corresponding to the victim line and values of at least two of the aggressor lines from having a logic high value.

17. The method of claim 16, wherein the plurality of data lines include an even number of rows, each of the plurality of symbols includes 2 bits, and a plurality of base values sₖ corresponding to the plurality of symbols have the relationship as follows: s₀=1, s₁=4, sᵢ₊₂=3sᵢ₊₁+2sᵢ (i≥0), where i is a symbol number and k is a column number.

18. The method of claim 16, wherein the plurality of data lines include an odd number of rows, each of the plurality of symbols corresponding to an even row includes 2 bits, each of the plurality of symbols corresponding to an odd row includes 1 bit, and a plurality of base values sₖ corresponding to the plurality of symbols have the relationship as follows: s₀=1, s₁=4, s₂ᵢ=s₂ᵢ₋₁+3s₂ᵢ₋₂, s₂ᵢ₊₁=4s₂ᵢ (i≥1), where i is a symbol number and k is a column number.

19. The method of claim 15, wherein generating the previous transmission data comprises providing a corresponding bit of the previous transmission data in response to a clock signal, and
wherein generating the transmission data comprises performing an XOR operation on the corresponding bit of the previous transmission data and a corresponding bit of the encoding data to generate a corresponding bit of the transmission data.

20. The method of claim 11, wherein the plurality of data lines transmit the transmission data in a high bandwidth memory (HBM) device.
